(19) United States
(12) Patent Application Publication
(10) Pub. No.: US 2008/0293005 A1
(43) Pub. Date: Nov. 27, 2008

(54) ADJUSTABLE ORTHODONTIC BRACKET

(76) Inventors: Roman Rahlis, Holon (IL); Vladimir Matskel, Netanya (IL); Shmuel Kornhauser, Ra'anan (IL); Vladimir Arav, Netanya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/125,077

(22) Filed: May 22, 2008

Related U.S. Application Data
(60) Provisional application No. 60/939,864, filed on May 24, 2007.

(51) Int. Cl. A61C 7/02; A61C 7/14

(52) U.S. Cl. 433/16; 433/3

(57) ABSTRACT

An adjustable orthodontic bracket including an body member for fixing orthodontic arch wire in a position such that a predetermined stress is generated and applied to the tooth to be treated; a bonding base member for bonding the bracket to a buccal or lingual surface of a tooth to be treated; and a bendable element, wherein the bendable element connects the body member to the bonding base member. The body member includes a slot for the arch wire, wherein the bendable element enables to adjust accurate angles of the slot. The bendable element can be rigid or flexible wherein in the flexible form, a holding device is further included. The present invention further provides tools to band and/or rotate the adjustable orthodontic bracket of the present invention.

### CROSS REFERENCE TO RELATED APPLICATIONS

This application claims the benefit under 35 USC 119(e) from U.S. provisional application 60/939,864 filed May 24, 2007, the disclosure of which is included herein by reference.

### FIELD OF THE INVENTION

This patent relates to orthodontic devices and methods and more particularly, to adjustable orthodontic bracket adjustable bracket for use in conjunction that enables to adjust the force conveyed to the tooth without removing the arch wire, and enables to accurately adjust the angles of the bracket wire slot. The present invention further provides tools for bending the adjustable bracket of the present invention.

### BACKGROUND OF THE INVENTION

Orthodontic accessories are used for three-dimensional re-positioning of teeth. A common orthodontic method applies force on a tooth is by means of a plastic flexible arch wire which enables adjusting the size and the direction of the force of the arch wire on a tooth by changing the force on the inside slot of a bracket, which is firmly attached to the tooth. In order to convey force onto a tooth, the shape of the arch wire is modified and/or the bracket is bent and/or rotated.

U.S. Pat. No. 4,243,387 ('387) “Adjustable orthodontic brackets”, given to Steven P. Prins, provides a bracket that enables adjusting the force which acts on the tooth by changing the position of the slot inside which the wire is being inserted. The bracket has a base that is affixed to the tooth, and a movable member to which wires are attached, and a retainer to fix the movable member to the base. In the preferred embodiment, the base and the movable member includes spherical surfaces so that motion of the movable member can dispose the bracket at any desired angle in any plane for the desired torque. In all embodiments the movable member is can rotate 360° about the retainer and can be set at any desired angle.

There are brackets with different bending angles for different types of treatment and clinical cases. See for example, “DENTAURUM ORTHODONTICS CATALOG NO. 15 ENGLISH ('15), Orthodontics 2006, Innovative products for high standards dentaurum, p. 57-87.

PCT application WO/2006/024119 ('119) “Disposition applied in bi-divided bracket with adjustable articulation”, by Daniel Ianni Filho, provides an adjustable bracket with an adjustable articulation mechanism that can turn about a lateral axis.

The disadvantages of prior art bendable brackets as exemplified by disclosures ('387), ('119) and ('15) are:
a) It is not possible to adjust the force on the tooth without removing the wire and/or change in the bracket position with respect to the tooth.
b) It is relatively hard to manufacture due to the small dimensions of the bracket.
c) The bracket has relatively complicated structure, having at least three parts, which reduces the bracket reliability.
d) It is not possible to adjust accurate angles of the wire slot.
e) Different types of bracket sets have to be used.

There is therefore a need and it would be advantageous to have a bracket for use in conjunction that enables to adjust the force conveyed to the tooth without removing the arch wire, and enables to accurately adjust the angles of the bracket slot. There is a further need for brackets that can set bracket slot angles, right before installing them on the tooth, according to each clinical case.

### SUMMARY OF THE INVENTION

According to the teaching of the present invention include providing an adjustable orthodontic bracket including:
a) a body member for fixing orthodontic arch wire in a position such that a predetermined stress is generated and applied to the tooth to be treated;
b) a bonding base member for bonding the bracket to a buccal or lingual surface of the tooth to be treated; and
c) a bendable element,
   wherein the bendable element connects the body member to the bonding base member and wherein the bendable element is generally perpendicular to the buccal or lingual surface of the tooth and wherein the bonding base member further includes a distal surface, with respect to the buccal or lingual surface of the tooth, wherein the distal surface is generally parallel to the surface of the tooth; and
   wherein the body member includes, on the distal surface with respect to the surface of the tooth, a wire slot for the arch wire, and wherein the bendable element enables to adjust accurate angles of the wire slot.

In embodiments of the present invention, the bendable element, the body member and the bonding base member are made from one piece.

In embodiments of the present invention, the bendable element, the body member and the bonding base member are made from separate pieces.

In embodiments of the present invention, the bendable element and the bonding base member are made from one piece.

In embodiments of the present invention, the bendable element and the body member are made from one piece.

Typically, the bendable element is connected to the bonding base member and to the body member, substantially at the center of the bonding base member and the body member. The bendable element can be shaped in any form, selected from the group including: a wire, cylindrical, spherical, parallelepiped, conical, hollow and any other form.

In embodiments of the present invention, the bendable element can be made of flexible, non-rigid materials, in which case the bracket further includes a holding device for setting the proximal surface of the body member at a desired angle and orientation with respect to the buccal or lingual surface of the tooth. The distal surface of the holding device has an upper surface and a lower surface, wherein the upper surface is inclined with respect to the lower surface, forming a pre-designed angle.

In embodiments of the present invention, the bendable element is made of generally rigid materials, whereas the force M_{BE} required for bending, rotating or both bending and rotating the bendable element, is:

M_{W}<M_{BE}<M_{TB}

where M_{W} is the force applied by arch wire, and M_{TB} is the force binding the bonding base member to the buccal or lingual surface of the tooth; and whereas

M_{M}<M_{BE}

where M_{M} is the force applied by the arch wire and in addition, any other force applied onto the bracket during eating, speaking or any other activity taking place in the mouth hosting the bracket.

Further teachings of the present invention include providing tools for adjusting the adjustable bracket of the present invention. The tools enables to apply controlled force vectors required to bend the bracket, or rotate the bracket or both bend and rotate the bracket.

One tool for bending the bracket of the present invention includes a flat, thin part and a wedge part, wherein the thin part is inserted between the distal surface of the bonding base and the proximal surface of the body member, and wherein the wedge part is forcefully inserted between the distal surface of the bonding base and the proximal surface of the body member, thereby deflecting the bondable element, and thereby the wire slot of the bracket, towards the thin part. The operator forces the wedge part inwardly until the desired bending angle is obtained or until the thin part blocks the bracket from being further bended. The thin part is selected with a width dimension according to the required bending angle of the bracket.

In embodiments of the present invention, the tool is a rotating tool, which includes a head. Typically, the head is operatively engaged with a second slot disposed at the top of the body member, being an accessory slot. The head may also be designed to be operatively engaged with the wire slot or any other part of the body member. The rotating tool further may further include a holding part for holding the bonding base member steady, thereby preventing rotation of the bonding base member with respect to the tooth.

In embodiments of the present invention, the rotating tool is also a bending tool, wherein a delimiting accessory tool, which includes a flat, thin part, is inserted between the distal surface of the bonding base and the proximal surface of the body member, and wherein the bending tool is operated to deflect the bondable element towards the thin part of the delimiting accessory tool.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a side view illustrating of the orthodontic bracket, according to embodiments of the present invention;

FIG. 2 is a side view illustrating of the orthodontic bracket shown in FIG. 1, after adjustment;

FIG. 3 is a perspective view of the orthodontic bracket shown in FIG. 1, in a rotated position;

FIG. 4 is a perspective view illustrating of the orthodontic bracket shown in FIG. 1, whereas the bracket holds an arch wire;

FIG. 5 is a cross section of the orthodontic bracket shown in FIG. 1;

FIG. 6 is a cross section of an embodiment of an orthodontic bracket assembled from two parts, according to embodiments of the present invention;

FIG. 7 is a cross section of an embodiment of an orthodontic bracket assembled from three parts, according to embodiments of the present invention;

FIG. 8 is a cross section of an embodiment of an orthodontic bracket assembled from two parts, according to embodiments of the present invention;

FIG. 9 schematically illustrates an embodiment of an orthodontic bracket, according to embodiments of the present invention, having a spherical adjustment mechanism;

FIG. 10 is a perspective illustration of the orthodontic bracket, shown in FIG. 1, with a flexible bendable element and an inclined holding device, according to embodiments of the present invention;

FIG. 11 is a cross section side view illustrating the orthodontic bracket shown in FIG. 9, having a flexible spherical adjustment mechanism, being held by the inclined holding device shown in FIG. 10;

FIG. 12 is a cross section side view illustrating of an embodiment of an orthodontic bracket, according to embodiments of the present invention, having a flexible bendable element and being held by the inclined holding device shown in FIG. 10;

FIG. 13 is a cross section side view illustrating of the orthodontic bracket shown in FIG. 9, having a self held spherical adjustment mechanism;

FIG. 14 is a side view illustrating of the orthodontic bracket shown in FIG. 1, being bent by a bending tool, according to embodiments of the present invention, wherein the bending force or a portion of the bending force is not transferred to the tooth;

FIG. 15 is a perspective view of an example bending tool;

FIG. 16 is a perspective partial view of the bending tool shown in FIG. 15, bending the orthodontic bracket shown in FIG. 1;

FIG. 17 is a perspective view of a rotating tool, according to embodiments of the present invention, rotating the orthodontic bracket shown in FIG. 1 and wherein the rotation force or a portion of the rotation force is not transferred to the tooth;

FIG. 18 is a perspective view of a bending and rotating tool, according to embodiments of the present invention, wherein at least a portion of the bending force is transferred to the tooth;

FIG. 19 is a perspective view of an accessory tool, according to embodiments of the present invention;

FIG. 20 is a side partial view of a rotating and bending tool, similar to the tool shown in FIG. 18, and the accessory tool shown in FIG. 19, bending the orthodontic bracket shown in FIG. 1, wherein the bending force or a portion of the bending force is not transferred to the tooth;

FIG. 21 is a perspective partial view of a rotating and bending tool, rotating the orthodontic bracket shown in FIG. 1 and wherein the rotation force or a portion of the rotation force is not transferred to the tooth;

FIG. 22 is a side view of another embodiment of an orthodontic bracket, according to embodiments of the present invention; and

FIG. 23 is a side view of another embodiment of an orthodontic bracket, according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

The principal intentions of the present invention include providing an adjustable orthodontic bracket which:
enables to adjust the force on the tooth without removing the wire;
enables to adjust accurate angles of the arch wire slot; and
enables to adjust the arch wire slot angle right before installing them on the tooth, according to each clinical case.

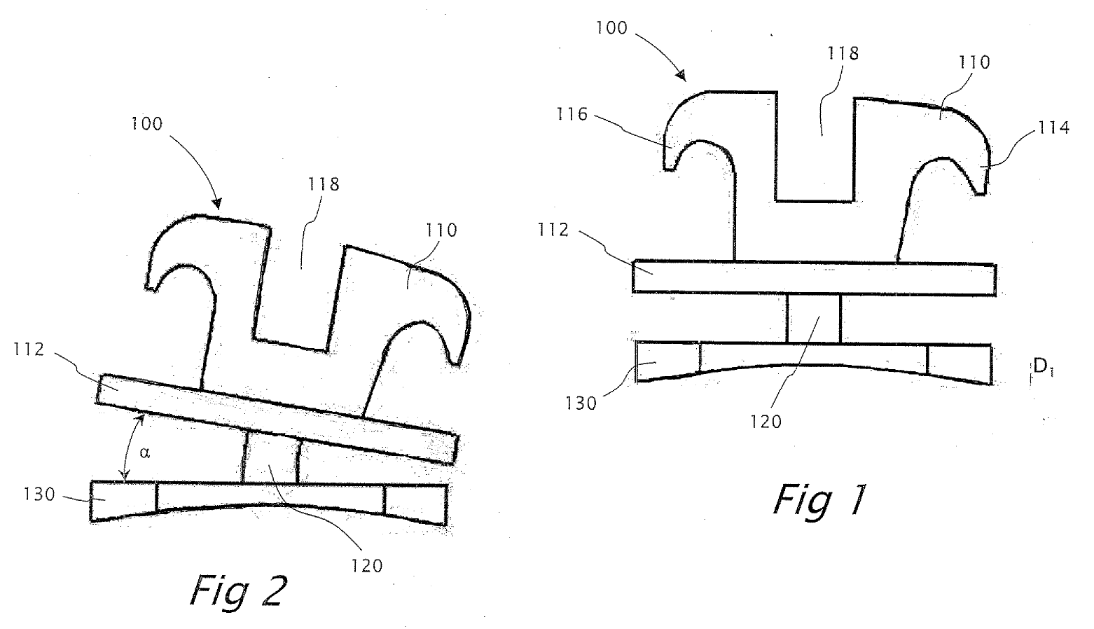

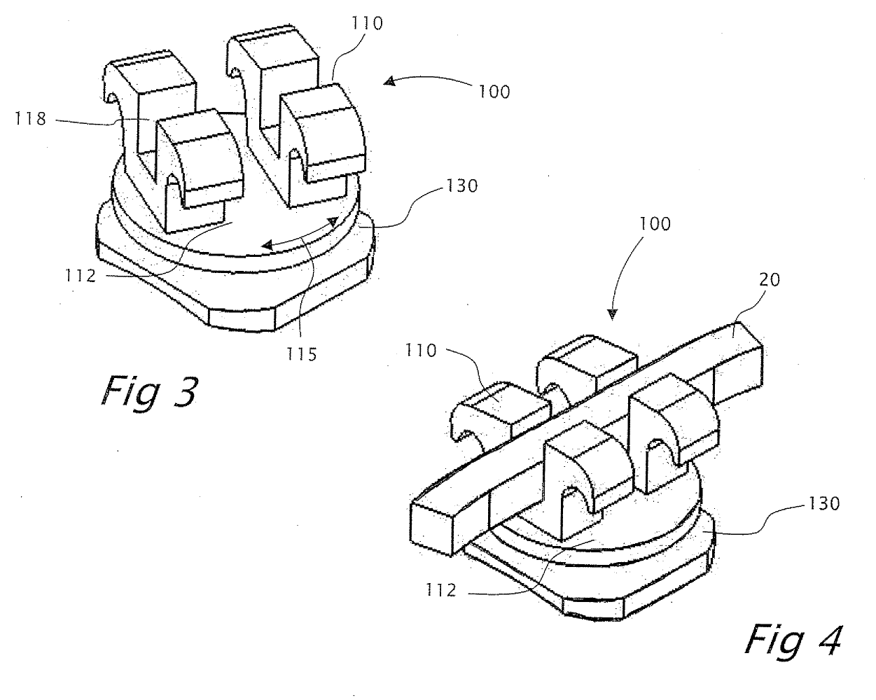

Reference is made to the drawings. FIG. 1 is a side view illustrating of adjustable orthodontic bracket 100, according to embodiments of the present invention; FIG. 2 is a side view illustrating of orthodontic bracket 100, after adjustment has been applied; FIG. 3 is a perspective view of orthodontic bracket 100, in a rotated position; and FIG. 4 is a perspective view illustrating of the orthodontic bracket 100, whereas bracket 100 holds arch wire 20.

Orthodontic bracket 100 includes body member 110, bonding base member 130 for bonding bracket 100 to the buccal or lingual surface of a tooth to be treated, a bendable element 120, which connects bonding base 130 to body base member 112 of body 110, and enabling a rotational movement of body 110 with respect to bonding base 130.

An arch wire 20 is typically attached to body 110 through wire slot 118 and operationally conveys pressure from arch wire 20 through body 110 to a bendable element 120, and then to bonding base 130 and then to the tooth to which bonding base 130 is affixed. The geometrical shape of bendable element 120 does not change, unless external force is applied to bendable element 120.

It should be noted the in order to prevent bendable element 120 from getting deformed from the force applied by arch wire 20, the force required to bend bendable element 120 must be greater than the strongest force commonly used to tighten arch wire 20:

M_{W}<M_{BE}<M_{TB}

where M_{W} is the force applied by arch wire 20;

M_{BE} is the force require to bend/rotate bendable element 120; and

M_{TB} is the force binding bracket 100 to the tooth,

and

M_{M}<M_{BE}
where M_{M} is the force applied by arch wire 20 and in addition, any other forces applied onto bracket 100 in the mouth during eating, chewing gum, speaking, etc.

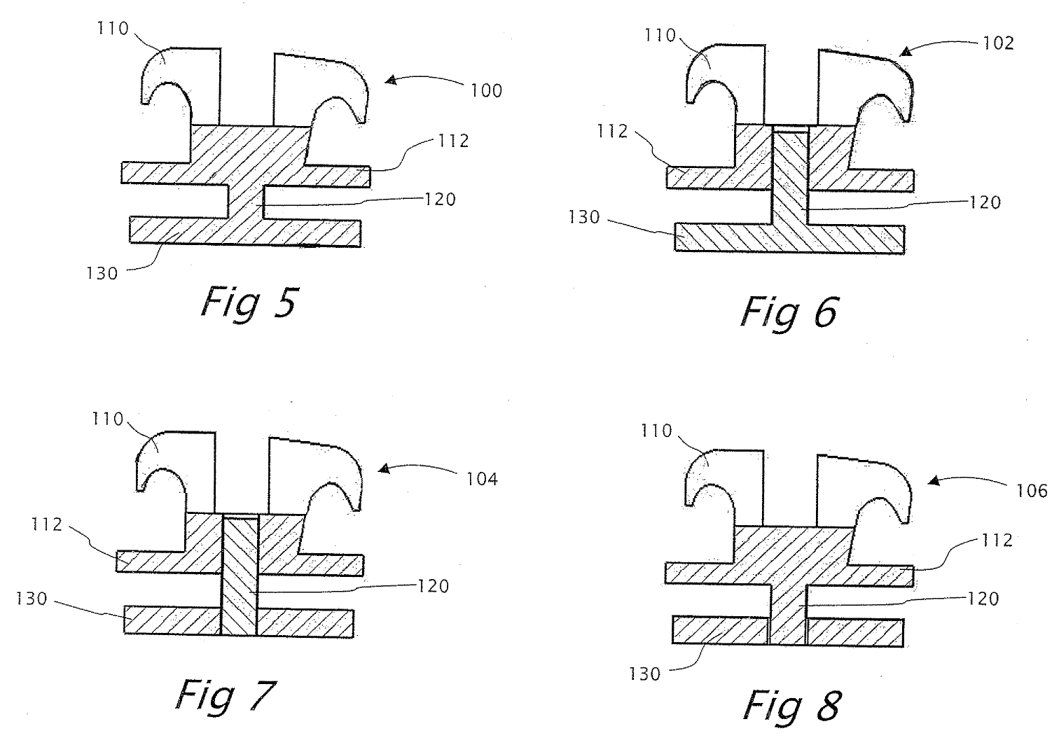

In the preferred embodiments of the present invention, body 110, bonding base 130 and bendable element 120 are made from one piece. FIG. 5 is a cross section side view of orthodontic bracket 100 illustrating the preferred embodiment of the present invention, whereas body 110, bonding base 130 and bendable element 120 are made from one piece.

In embodiments of the present invention, bonding base 130 and bendable element 120 are made from one piece, on which body 110 is assembled. FIG. 6 is a cross section side view of orthodontic bracket 102 assembled from body 110 mounted onto bonding base 130 and bendable element 120, which axe made from one piece.

In embodiments of the present invention, body 110, bonding base 130 and bendable element 120 are made from separate pieces. FIG. 7 is a cross section side view of orthodontic bracket 104 assembled from body 110, bonding base 130 and bendable element 120, all of which are made from separate pieces.

In embodiments of the present invention, body 110 and bendable element 120 are made from one piece. FIG. 8 is a cross section side view of orthodontic bracket 106 assembled from body 110 and bendable element 120, which are made from one piece, and from bonding base 130.

Bendable element 120 can be solid, hollow, round, square, rectangular and/or any other shape.

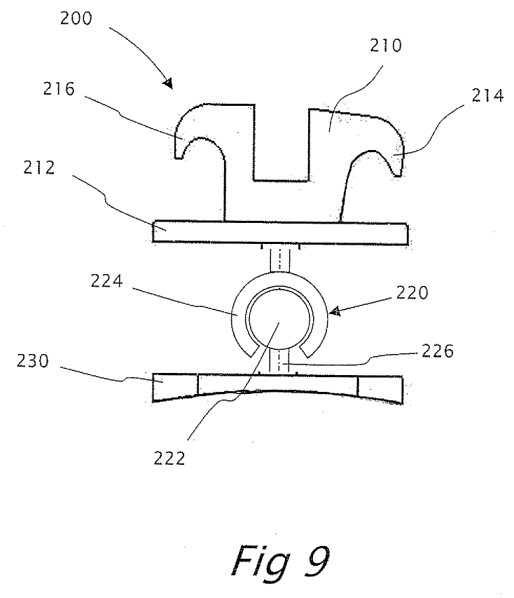

In embodiments of the present invention, the bendable element includes a spherical adjustment mechanism that operates as a ball and spheroid joint. FIG. 9 schematically illustrates an embodiment of an orthodontic bracket 200, according to embodiments of the present invention, having a spherical adjustment mechanism 220. Spherical adjustment mechanism 220 typically includes spherical element 222 and fitted complementing element 224 having a spherical cavity, which can move about spherical element 222 in any direction.

Typically, fitted element 224 cannot moves freely about spherical element 222. To move fitted element 224 about spherical element 222 external force is applied. The free movement of fitted element 224 about spherical element 222 is prevented by pre designed friction between elements 222 and 224, or by any other mechanism.

The present invention provides two primary types of orthodontic brackets (such as 100 and 200): a first type, having a self held bendable element (such as 120 and 220) and a second type having a flexible bendable element. In the first primary type, it is required that the force required to bend the bendable element must be greater than the strongest force commonly used to tighten arch wire 20 and any other forces applied in the mouth during eating, speaking, etc. In the second primary type, it is required that holding device will maintain the bending angle.

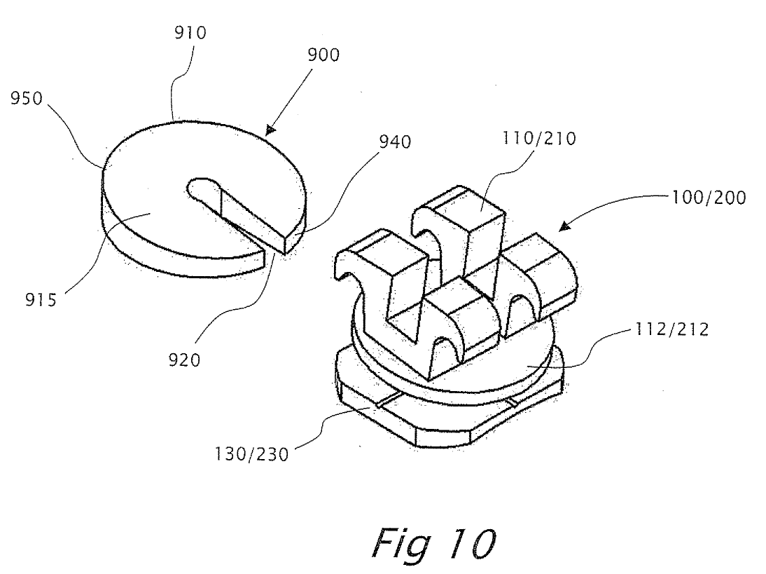

Example embodiments of the second primary type, in which a holding device is required to maintain the bending angle, will now be described. Referring now to FIG. 10, which is a perspective illustration of an orthodontic bracket of the present invention (such as 100 and 200). FIG. 10 further illustrates inclined holding device 900, according to embodiments of the present invention. Inclined holding device 900 is typically round, but can have any external shape. Inclined holding device 900 is operationally inserted between to upper surface of the bonding base (such as 130 and 230) and the lower surface of the body base (such as 112 and 212), in any circumferential direction (360°), as desired by the orthodontist. The slope of upper surface 915 of inclined holding device 900 with respect to the lower surface of inclined holding device 900 is selected according to the desired adjustment needed to apply to the orthodontic bracket. Upper surface 915 of holding device 900 forms a narrow side 940 and a wide side 950. Inclined holding device 900 further includes a slit 920 to allow holding device 900 to move beyond the flexible bendable element, having the flexible bendable element pass through slit 920, whereas the inner end of slit 920 serves as a stopper when reaching the flexible bendable element.

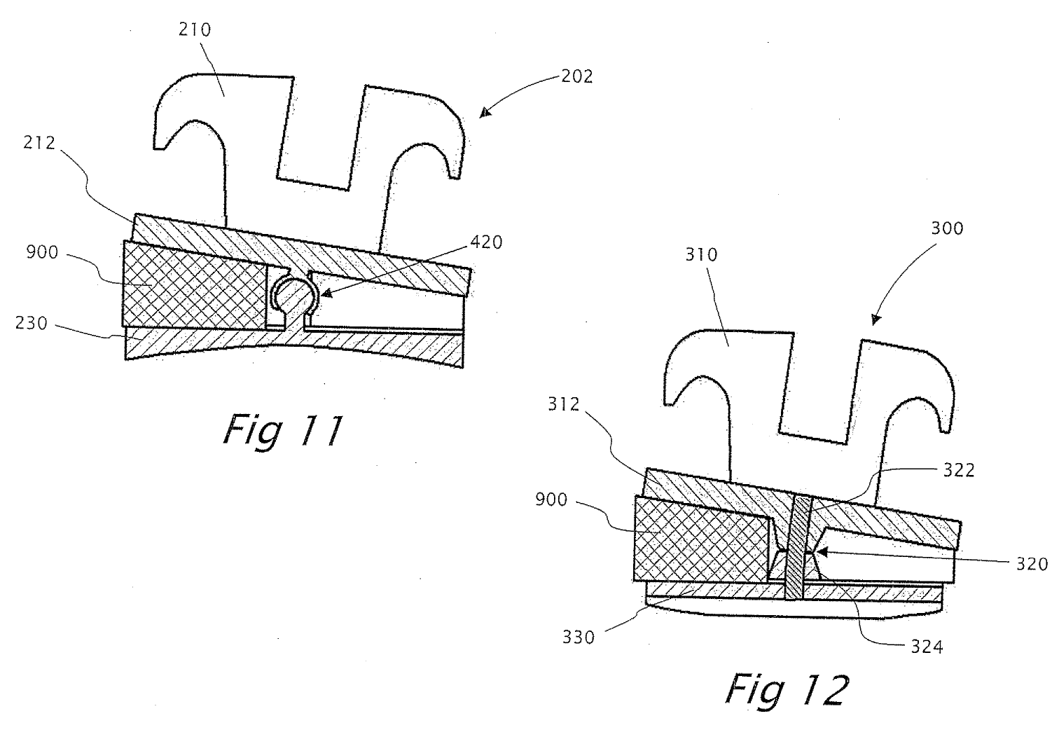

Reference is also made to FIG. 11, which is a cross section side view illustrating orthodontic bracket 202, bent by inclined holding device 900. As inclined holding device 900 is inserted into orthodontic brackets 200, freely bendable element 220 bends as upper surface 915 of inclined holding device 900 conveys the orientation of surface 915 to body base 112. When inclined holding device 900 is fully inserted into orthodontic bracket 202, bracket 202 is deflected such that the lower surface of body base 212 coincides with upper surface 915 of inclined holding device 900.

In embodiments of the present invention, bendable element 120 is made of flexible, non-rigid materials, complemented by rigid supporting mechanism. FIG. 12 is a cross section side view illustrating of an embodiment of orthodontic bracket 300, according to embodiments of the present invention, having a flexible center part 322 and being held by inclined holding device 900. Flexible center part 322 connects body base 312 of body 310 to bonding base 330. Bending mechanism 320 further includes rigid supporting elements 324, which helps to maintain bending angle α.

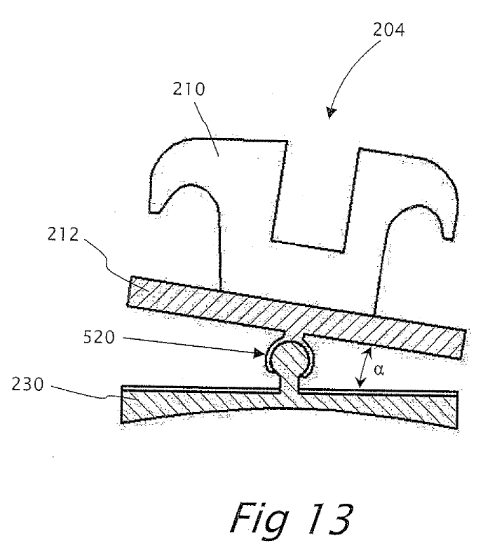

Example embodiments of the first primary type, in which a holding device is required to maintain the bending angle, will now be described. FIG. 13, which is a cross section side view illustrating of orthodontic bracket 204, having a self held spherical adjustment mechanism 520. Body 210 is bent with respect to bonding base 230, and thereby body base 212 forms an angle α with respect to boding base 230.

To adjust the orthodontic brackets of the first primary type of the present invention, bending and rotating tools have been developed, according to embodiments of the present invention. The bending and rotating tools are divided into three categories: bending tools, rotating tools and tools for both bending and rotating. The tools of the present invention may further include accessories to support the tools. Typically, the head of the tools is operatively engaged with a second slot disposed at the top of the body member, being an accessory slot. The head may also be designed to be operatively engaged with the wire slot or any other part of the body member.

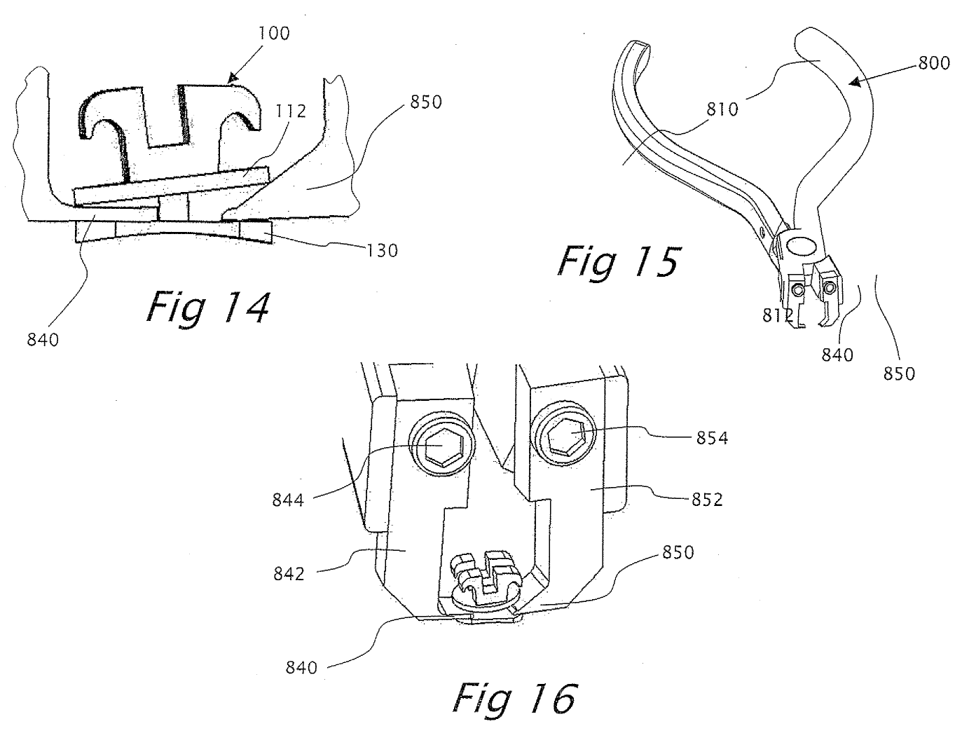

FIG. 14 is a side view illustrating of orthodontic bracket 100 being bent by one type of bending tools, according to embodiments of the present invention. The bending tool includes flat, thin part 840 and wedge 850. The thickness of thin part 840 operationally determines the maximal angle at which bracket 100 will be bent. Wedge 850 is forcefully inserted between the upper surface of bonding base 130 and the lower surface of body base 112, thereby deflecting bracket 100 towards thin part 840. The operator forces wedge part 850 inwardly until the desired bending angle is obtained or until the thin part 840 blocks bracket 100 from being further bended.

FIG. 15 is a perspective view of an example bending tool 800. FIG. 16 is a perspective partial view of bending tool 800, bending orthodontic bracket 100. Bending tool 800 operates according to the type of bending tools shown in FIG. 14. When forcefully pushing handles 810 towards each other, arms 842 and 852 also move towards each other. Thin part 840 stops the changing of the gap between the upper surface of bonding base 130 and the lower surface of body base 112, when reaching bendable element 120. Wedge 850 is further enters the gap between the upper surface of bonding base 130 and the lower surface of body base 112, thereby bending bracket 100 towards thin part 840. The bending stops when the lower surface of body base 112 reaches the upper surface of thin part 840. Arms 842 and 852 can be replaced by opening attaching elements such as screws 844 and 854, respectively. Thin part 840 is selected according to the required bending angle α.

In embodiments of the present invention, the movement of arms 810 towards each other is delimited by adjustment screw 812, thereby setting the resulted bending angle α.

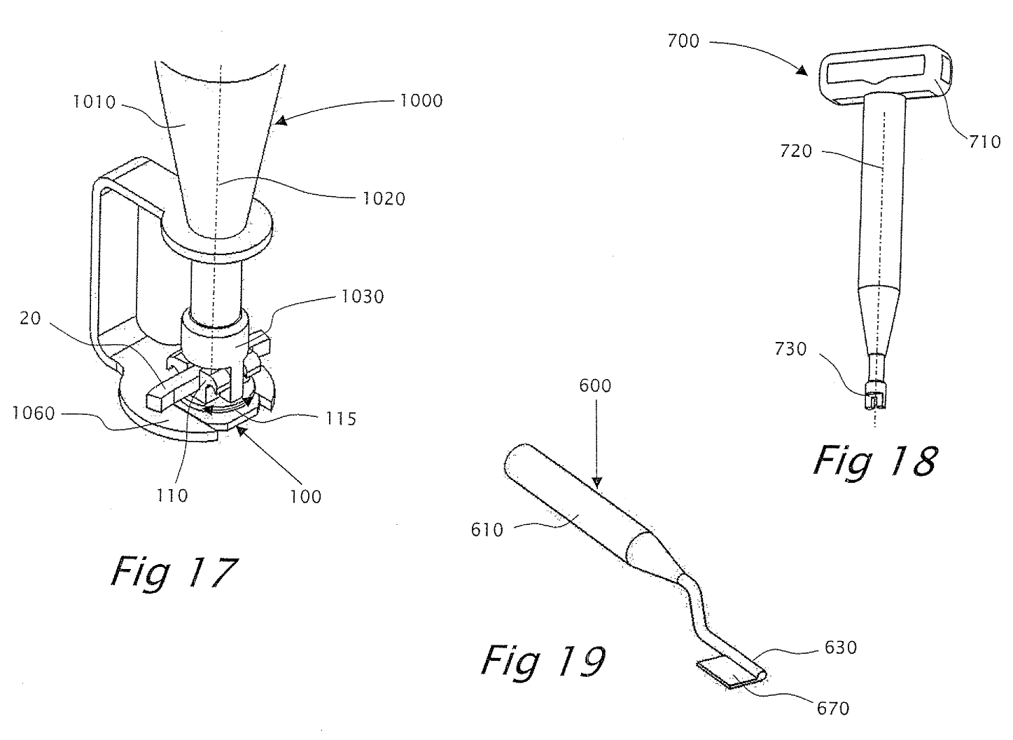

FIG. 17 is a perspective view of rotating tool 1000, according to embodiments of the present invention, rotating orthodontic bracket 100. Tool 1000 includes head 1030 designed to fit the upper portion of body 110 of bending bracket 100, such that when turning handle 1010 about longitudinal axis 1020 of tool 1000, body 110 of bending bracket 100 turns with respect to bonding base 130, in directions 115. When the rotation force applied by rotating tool 1000 is stronger than the binding force of bracket 100 to the tooth, holding part 1060 holds bonding base 130 steady, to prevent rotation of bonding base 130, and thereby damaging the bonding of bracket 100 to the tooth.

FIG. 18 is a perspective view of a rotating and bending tool 700, according to embodiments of the present invention. Tool 700 includes head 730 designed to fit the upper portion of body 110 of bracket 100, such that when turning handle 710 about longitudinal axis 720 of tool 700, body 110 of bracket 100 turns with respect to bonding base 130, in directions 115.

FIG. 21 is a perspective partial view of rotating and bending tool 700, rotating orthodontic bracket 100 in directions 115.

FIG. 19 is a perspective view of accessory tool 600, according to embodiments of the present invention. Accessory tool 600 includes a handle 610 and part 670 disposed at the end distal from handle 610. Part 670 typically serves as a bending delimiting device, as does thin part 840 of tool 800. Accessory tool 600 typically has a precise and uniform width of thin part 670. Accessory tool 600 having the appropriate width is selected for a given bending task.

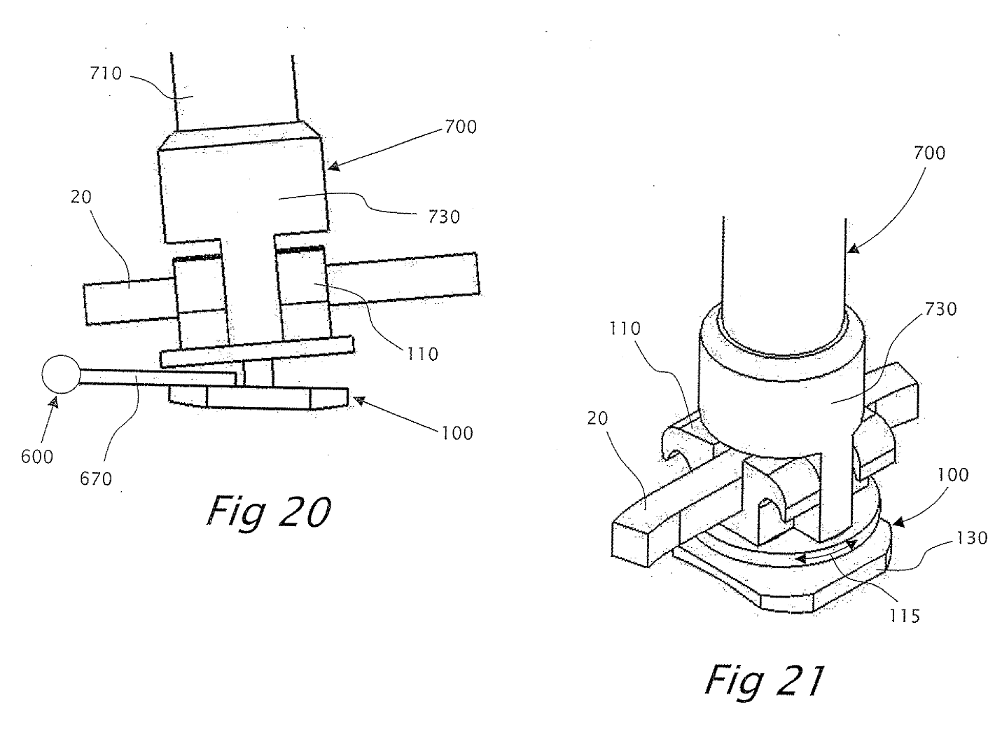

FIG. 20 is a side partial view of rotating and bending tool 700, bending orthodontic bracket 100, whereas thin part 670 of accessory tool 600 is used to delimit the bending angle.

It should be noted that the adjustment of bracket 100 in one of the planes of motion can be accomplished without affecting the adjustment of bracket 100 in any of the other planes of motion.

It should be further noted that tools such as 800 and 1000 do not apply, directly or indirectly forces on the bonding of the brackets of the present invention to the tooth. Tools such as 700 may apply direct or indirect forces on the bonding of the brackets of the present invention to the tooth.

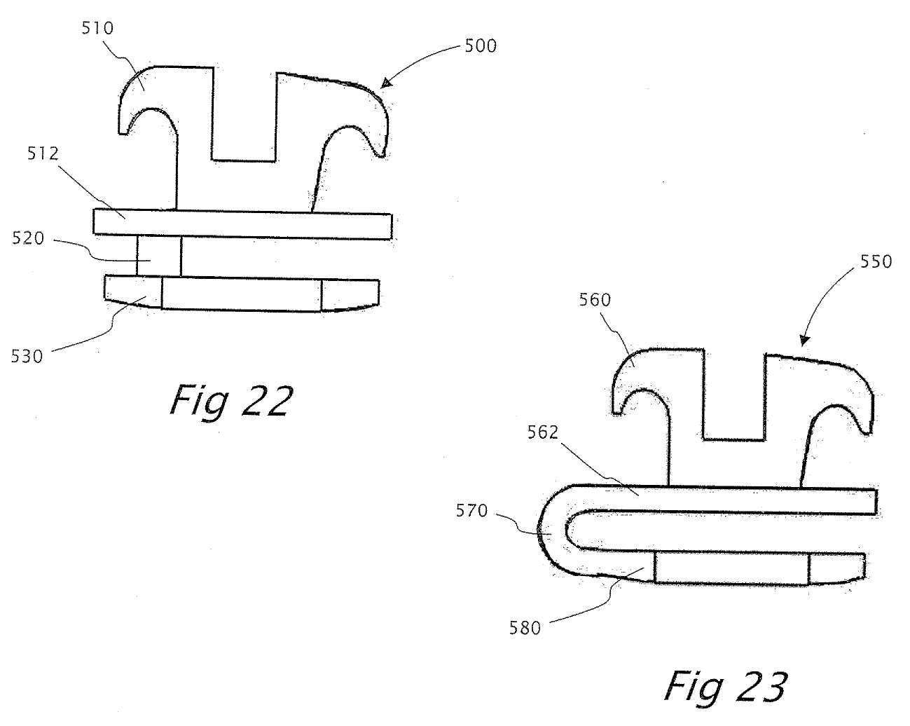

Reference is now made to FIG. 22, which is a side view of another embodiment of an orthodontic bracket 500, according to embodiments of the present invention. Orthodontic bracket 500 includes body 510, bonding base 530 for bonding bracket 500 to the buccal or lingual surface of a tooth, a bendable element 520, which connects bonding base 530 to body base 512 of body 510, and enabling a rotational movement of body 510 with respect to bonding base 530. Orthodontic bracket 500 differs from orthodontic bracket 100 in the disposition of bendable elements 520 and 120. Bendable element 120 is disposed substantially at the center of bonding base 130, while bendable element 520 is disposed off the center of bonding base 530.

Reference is now made to FIG. 23, which is a side view of another embodiment of an orthodontic bracket 550, according to embodiments of the present invention. Orthodontic bracket 550 includes body 560, bonding base 580 for bonding bracket 550 to the buccal or lingual surface of a tooth, a bendable element 570, which connects bonding base 580 to body base 562 of body 560, and enabling a rotational movement of body 560 with respect to bonding base 580. Orthodontic bracket 550 differs from orthodontic bracket 100 in the disposition of bendable elements 570 and 120. Bendable element 120 is disposed substantially at the center of bonding base 130, while bendable element 570 is disposed at the circumference of bonding base 580.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. An adjustable orthodontic bracket comprising:
a) a body member for fixing orthodontic arch wire in a position such that a predetermined stress is generated and applied to the tooth to be treated;
b) a bonding base member for bonding the bracket to a surface of the tooth to be treated; and
c) a bendable element,
wherein said bendable element connects said body member to said bonding base member and wherein said bendable element is generally perpendicular to said surface of said tooth and wherein said bonding base member further comprises a distal surface, with respect to said surface of the tooth, wherein said distal surface is generally parallel to said surface of said tooth; and
wherein said body member comprises, on the distal surface with respect to said surface of the tooth, a wire slot for the arch wire, and wherein said bendable element enables to adjust accurate angles of said wire slot.

2. The bracket of claim 1, wherein said bendable element, said body member and said bonding base member are made from one piece.

3. The bracket of claim 1, wherein said bendable element, said body member and said bonding base member are made from separate pieces.

4. The bracket of claim 1, wherein said bendable element and said bonding base member, are made from one piece.

5. The bracket of claim 1, wherein said bendable element and said body member, are made from one piece.

6. The bracket of claim 1, wherein said bendable element is connected to said bonding base member, substantially at the center of said bonding base member and wherein said bendable element is connected to said body member, substantially at the center of said body member.

7. The bracket of claim 1, wherein said bendable element is shaped in any form, selected from the group including: a wire, cylindrical, spherical, parallelepiped, conical, hollow and any other form.

8. The bracket of claim 1, wherein said bendable element is made of flexible, non-rigid materials, and wherein the bracket further comprises a holding device for setting said proximal surface of said body member at a desired angle and orientation with respect to said surface of said tooth.

9. The bracket of claim 1, wherein said surface of said tooth is selected from the group consisting: buccal, lingual.

10. The bracket of claim 8, wherein said distal surface of said holding device has an upper surface and a lower surface, wherein said upper surface is inclined with respect to said lower surface, forming a pre-designed angle.

11. The bracket of claim 1, wherein said bendable element is made of generally rigid materials, whereas the force M_{BE} required for bending, rotating or both bending and rotating said bendable element, is:
M_{W}<M_{BE}<M_{TB}
where M_{W} is the force applied by said arch wire, and M_{TB} is the force binding said bonding base member to said buccal or lingual surface of said tooth;
and whereas
M_{M}<M_{BE}
where M_{M} is the force applied by arch wire and in addition, any other force applied onto the bracket during eating, speaking or any other activity taking place in the mouth hosting the bracket.

12. A tool for adjusting the bracket of claim 1, wherein said tool enables to apply a controlled force vector required to bend the bracket, or rotate the bracket or both bend and rotate the bracket.

13. The tool of claim 12, wherein said tool comprises a flat, thin part and a wedge part, wherein said thin part is inserted between said distal surface of said bonding base and said proximal surface of said body member, and wherein said wedge part is forcefully inserted between said distal surface of said bonding base and said proximal surface of said body member, thereby deflecting said bondable element, and thereby said wire slot of the bracket, towards said thin part.

14. The tool of claim 13, wherein said thin part is selected a width dimension according to the desired bending angle.

15. The tool of claim 12, said tool is a rotating tool comprising a head, wherein said head is operatively engaged with a second slot disposed at the top of said body member, being an accessory slot.

16. The tool of claim 15, wherein said rotating tool further comprises a holding part for holding said bonding base member steady, thereby preventing rotation of said bonding base member with respect to said tooth.

17. The tool of claim 15, wherein said rotating tool is also a bending tool, wherein a delimiting accessory tool comprising a flat, thin part is inserted between said distal surface of said bonding base and said proximal surface of said body member, and wherein said bending tool is operated to deflect said bondable element towards said thin part of said delimiting accessory tool.
